(19) United States
(12) Patent Application Publication
(10) Pub. No.: US 2026/0177220 A1
(43) Pub. Date: Jun. 25, 2026

(54) LENS FOR BLIND SPOT MONITOR AND BLIND SPOT MONITOR LIGHT EMITTING UNIT, AND BLIND SPOT MONITOR LIGHT EMITTER

(71) Applicant: MURAKAMI CORPORATION, Shizuoka (JP)

(72) Inventors: Dinh Van DONG, Yaizu-shi (JP); Ryosuke MURATA, Yaizu-shi (JP)

(73) Assignee: MURAKAMI CORPORATION, Shizuoka (JP)

(21) Appl. No.: 19/401,718

(22) Filed: Nov. 26, 2025

(30) Foreign Application Priority Data
Dec. 23, 2024 (JP) 2024-226595

(51) Int. Cl. F21S 43/31

(52) U.S. Cl. CPC F21S 43/31

(57) ABSTRACT

A lens for a blind spot monitor includes a front plate, a rear plate disposed facing a back side of the front plate with a cavity interposed therebetween, a coupling portion that integrally couples the front plate and the rear plate around the cavity, and an opening that allows the cavity to communicate with an external space of the cavity. The front plate has a characteristic of transmitting light while diffusing the light. The rear plate has a characteristic of reflecting light while diffusing the light on a front side facing the front plate. The opening is configured to enable light from a light source to be introduced into the cavity through the opening. Light from the light source that is transmitted through the front plate from the back side to the front side is used for light emission of an icon.

The disclosure of Japanese Patent Application No. 2024-226595 filed on Dec. 23, 2024 including the specification, drawings, claims and abstract is incorporated herein by reference in its entirety.

### BACKGROUND OF THE INVENTION

### Field of the Invention

The present invention relates to a lens for a blind spot monitor and a blind spot monitor light emitting unit, and a blind spot monitor light emitter, and reduces unevenness in light emission of an icon.

### Description of the Related Art

A blind spot monitor is a device that is mounted on a vehicle, and detects another vehicle approaching a host vehicle and causes an icon having a predetermined shape to emit light, thereby notifying a driver of the host vehicle of the approach of the other vehicle. A light emitter of the blind spot monitor is provided with a lens that receives light from a light source and surface-emits light. By passing this surface-emitted light through a light transmissive portion where the icon is drawn to shape the light, a display that emits light in the shape of the icon can be obtained. A conventional lens for a blind spot monitor is typically one with a lens cut applied to a surface of a light guide that is formed of a single colorless and transparent thick plate (e.g., that described in US 2016/0209000 A1).

Since the conventional lens is formed of a single thick plate, it is difficult to obtain a light emitting surface having uniform brightness over the entire area due to sink marks during molding, and unevenness in light emission of the icon is likely to occur. The present invention provides a lens for a blind spot monitor and a blind spot monitor light emitting unit, and a blind spot monitor light emitter that solve the problem in the prior art described above and reduce unevenness in light emission of an icon.

### SUMMARY OF THE INVENTION

A lens for a blind spot monitor of the present invention includes: a front plate; a rear plate disposed facing a back side of the front plate with a cavity interposed therebetween; a coupling portion that integrally couples the front plate and the rear plate around the cavity; and an opening that allows the cavity to communicate with an external space of the cavity, in which the front plate is configured to have a characteristic of transmitting light while diffusing the light, the rear plate is configured in such a manner that a front side of the rear plate facing the front plate has a characteristic of reflecting light while diffusing the light, the opening is configured to enable light from a predetermined light source to be introduced into the cavity through the opening, and the lens is configured to enable light from the light source that is transmitted through the front plate from the back side of the front plate to a front side of the front plate to be used for light emission of an icon. With this lens, it is possible to cause the front face of the front plate to emit light by introducing light from the light source into the cavity between the front plate and the rear plate, and reflecting the introduced light by the rear plate while diffusing the light and transmitting the light through the front plate while diffusing the light. In this case, since the cavity is positioned between the front plate and the rear plate, the front plate and the rear plate can be formed with a thin plate thickness. Thus, compared to a case in which the lens is formed of a thick plate having a combined size of the front plate, the cavity, and the rear plate, it is possible to reduce sink marks during molding and reduce unevenness in light emission of the icon.

In the lens of the present invention, the coupling portion may be configured to couple (continuously or discontinuously couple, as described later) the front plate and the rear plate along a circumferential direction of the cavity, and the cavity may be surrounded by the coupling portion and formed in a bag shape. With this configuration, since the cavity is surrounded by the coupling portion and formed in a bag shape, it is possible to restrain light introduced into the cavity from leaking around the cavity and efficiently cause the front face of the front plate to emit light.

In the lens of the present invention, the opening may be formed between the front plate and the rear plate. With this configuration, when the lens is manufactured by injection molding, the opening can be formed by removing a mold that forms the cavity.

The rear plate may be disposed inclined relative to the front plate toward the opening. With this configuration, since light introduced into the cavity can be efficiently reflected by the rear plate and caused to enter the front plate, it is possible to efficiently cause the front face of the front plate to emit light.

In the lens of the present invention, the lens may be made of an integrally-molded article of a cloudy plastic material having a characteristic of transmitting light while diffusing the light. With this configuration, it is possible to easily and inexpensively manufacture the lens that achieves the effects of the present invention.

A blind spot monitor light emitting unit of the present invention includes: a light source; and a lens that receives light from the light source, transmits the light, and emits the light from a predetermined light emitting surface, in which the lens includes a front plate that has the light emitting surface, a rear plate disposed facing a back side of the front plate with a cavity interposed therebetween, and an opening that allows the cavity to communicate with an external space of the cavity, the front plate is configured to have a characteristic of transmitting light while diffusing the light, the rear plate is configured in such a manner that a front side of the rear plate facing the front plate has a characteristic of reflecting light while diffusing the light, and light from the light source is disposed in such a manner that the light is introduced into the cavity through the opening. With this configuration, it is possible to reduce unevenness in light emission of the icon.

A blind spot monitor light emitter of the present invention includes: a light source; a lens that receives light from the light source, transmits the light, and emits the light from a predetermined light emitting surface; and a light transmissive portion that is disposed in front of the light emitting surface and shapes a cross-sectional shape of light emitted from the light emitting surface in a direction perpendicular to an optical axis into a predetermined icon shape, in which the lens includes a front plate that has the light emitting surface, a rear plate disposed facing a back side of the front plate with a cavity interposed therebetween, and an opening that allows the cavity to communicate with an external space of the cavity, the front plate is configured to have a characteristic of transmitting light while diffusing the light, the rear plate is configured in such a manner that a front side of the rear plate facing the front plate has a characteristic of reflecting light while diffusing the light, light from the light source is disposed in such a manner that the light is introduced into the cavity through the opening, and the light source is disposed at a position that is not visible through the light transmissive portion when the light emitting surface is viewed from a front. With this configuration, since the light source is not directly visually recognized or is unlikely to be visually recognized through the light emitting surface, it is possible to reduce unevenness in light emission of the icon caused by point light (a state in which the light source position appears to shine brightly like a point).

### BRIEF DESCRIPTION OF THE DRAWINGS

FIG. 1 is a sectional side view showing an embodiment of a lens for a blind spot monitor (hereinbelow, abbreviated as “BSM”) and a BSM light emitting unit, and a BSM light emitter according to the present invention, showing a state in which the BSM light emitting unit is mounted on a back face (rear face) of a mirror plate of an outer mirror for a vehicle, together with the behavior of light emitted from a lit light source;

FIG. 2 is an exploded perspective view of the BSM light emitting unit and the mirror plate (for a vehicle right-side outer mirror) in FIG. 1, showing a state viewed from diagonally above the front side of the mirror plate;

FIG. 3A is a perspective view of the lens of FIGS. 1 and 2 viewed from diagonally above one of the left and right sides of the back side of the lens;

FIG. 3B is a diagram of the lens viewed from diagonally above the other of the left and right sides of the back side of the lens;

FIG. 3C is a front view of the lens (a view from the front of a light emitting surface);

FIG. 3D is a back view (rear view) of the lens;

FIG. 3E is a plan view (top view) of the lens;

FIG. 3F is a bottom view (underside view) of the lens;

FIG. 3G is a left side view of the lens;

FIG. 4 is a diagram showing a display position of an icon that is virtually projected onto the light emitting surface of the lens and indicated by a dashed line, the diagram being viewed from the same direction as FIG. 3C; and

FIG. 5 is a diagram of the BSM light emitting unit of FIG. 1 viewed from the front (the light emitting surface).

### DETAILED DESCRIPTION OF THE INVENTION

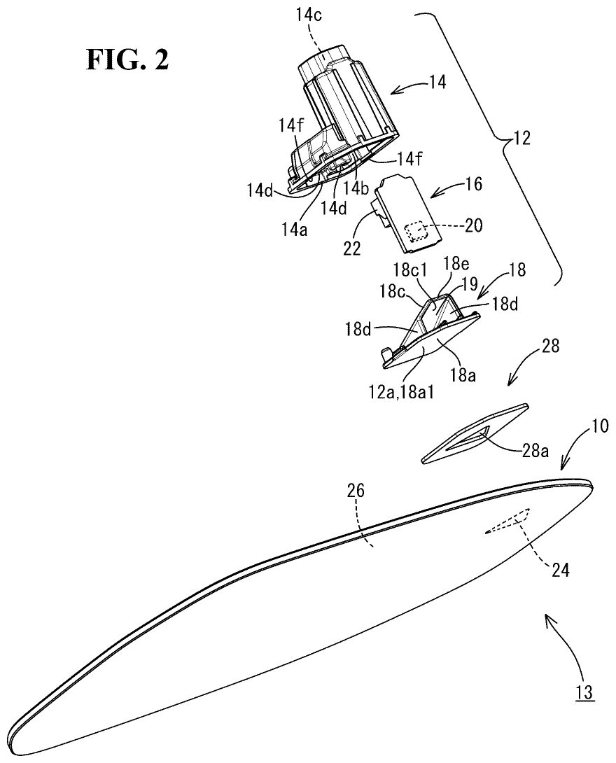

An embodiment of the present invention will be described. Note that, here, up, down, left, right, front, and rear (back) directions with respect to an outer mirror, a lens for a BSM, a BSM light emitting unit, and a BSM light emitter are defined as the directions when a mirror surface of the outer mirror equipped with the BSM light emitting unit is viewed from the front side, with the outer mirror mounted on a vehicle and disposed at an unfolded position (the non-retracted position, that is, the use position). FIG. 2 shows a BSM light emitting unit 12 mounted on a mirror plate 10 of a vehicle right-side outer mirror and a BSM light emitter 13 exploded into components. A mirror housing of the outer mirror is not shown. The BSM light emitting unit 12 is housed and disposed on the back side of the mirror plate 10 inside the mirror housing. This BSM light emitting unit 12 is for a vehicle right-side mirror. A BSM light emitting unit for a vehicle left-side mirror (not shown) has a structure bilaterally symmetrical to the BSM light emitting unit 12 for a vehicle right-side mirror. The BSM light emitting unit 12 is formed by integrally assembling a housing 14, a printed circuit board (PCB) 16, and a lens 18. The housing 14 is formed of, for example, a black opaque resin. In addition to an LED 20 that constitutes a light source, a connector 22 and other circuit elements are mounted on a lower face of the PCB 16. The lens 18 is a lens for a BSM according to the present invention. The BSM light emitting unit 12 is integrally assembled by inserting the PCB 16 in a horizontal position into an upper part of an internal space 14b through a front opening 14a of the housing 14 and fitting and attaching the lens 18 into the front opening 14a. A connector insertion port 14c for inserting a connector (not shown) of an external wire into the internal space 14b and detachably coupling the connector to the connector 22 of the PCB 16 is formed on a rear end of the housing 14. A light transmissive portion 24 having a predetermined icon shape (a triangular shape here) is formed on a back face of a peripheral edge part of the mirror plate 10 at a rightward position. The light transmissive portion 24 can be formed, for example, by removing a reflective film 26 in the predetermined icon shape at the position where the icon is to be formed on the back face of the mirror plate 10 by etching or the like. The integrally assembled BSM light emitting unit 12 is stuck and mounted onto the back face of the mirror plate 10 with double-sided adhesive tape 28. A window 28a that is open in the predetermined icon shape is formed within the surface of the double-sided adhesive tape 28. The BSM light emitting unit 12 is mounted on the back face of the mirror plate 10 by sticking one face of the double-sided adhesive tape 28 onto the back face of the mirror plate 10 with the position of the window 28a and the position of the light transmissive portion 24 aligned with each other and sticking a light emitting surface 12a (a front face 18a1 of the front plate 18a) of the BSM light emitting unit 12 onto the other face of the double-sided adhesive tape 28. The BSM light emitter 13 is formed in this way.

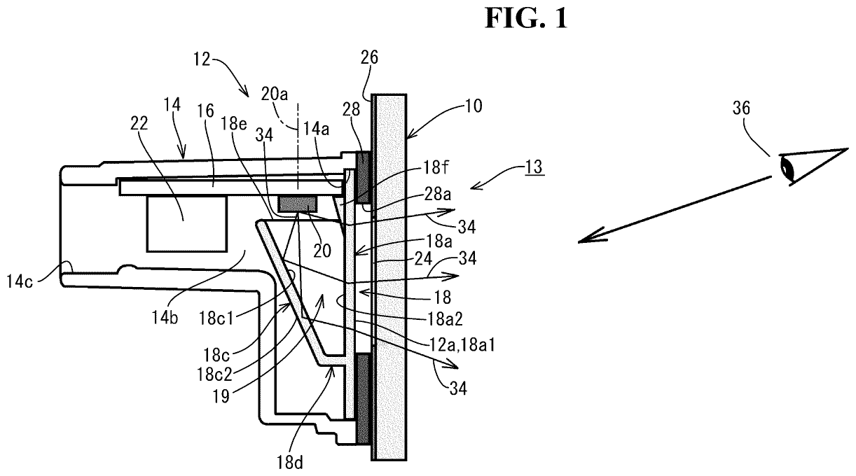

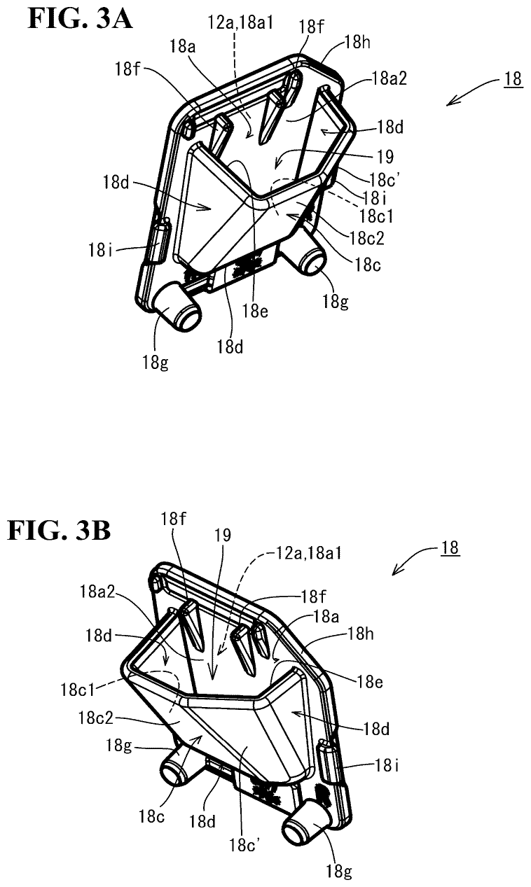

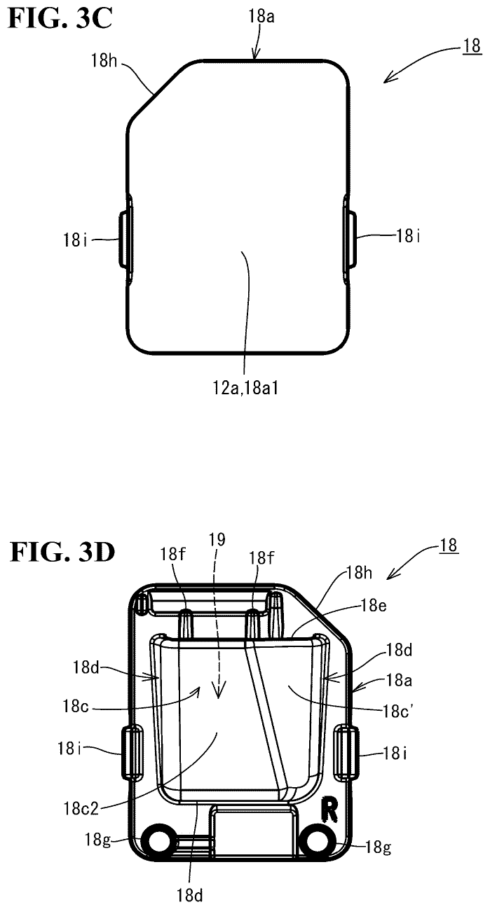

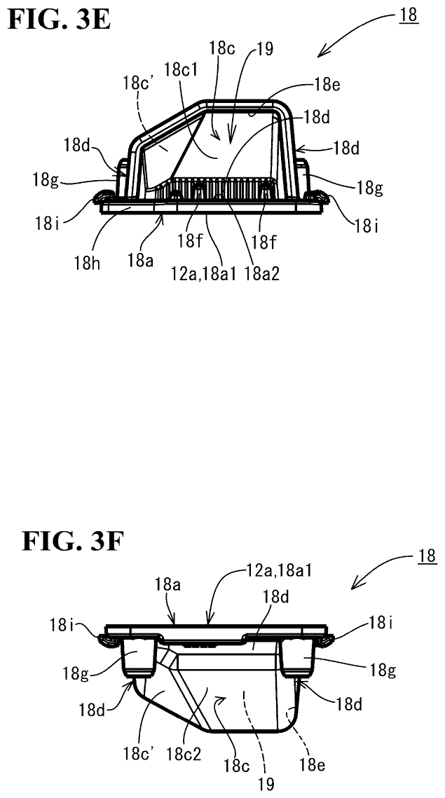

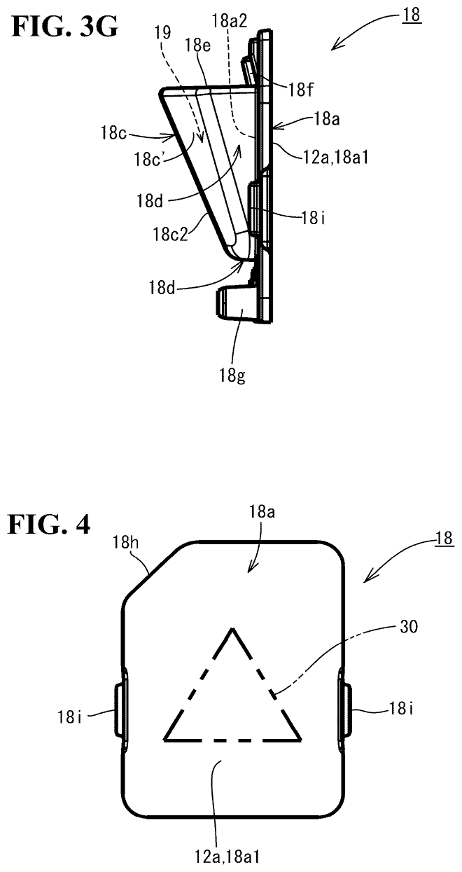

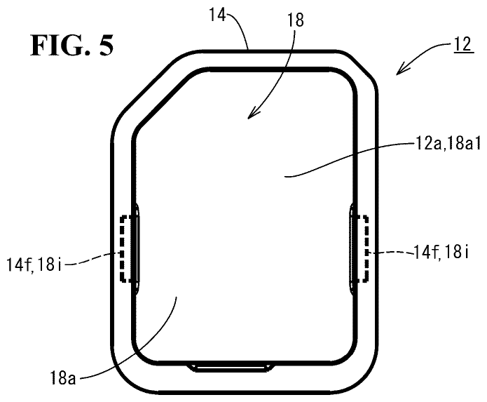

The configuration of the lens 18 will be described with reference to FIG. 3 (FIGS. 3A to 3G). The lens 18 is formed of, for example, an integrally molded article of a cloudy plastic material that has a translucent milky white color or the like and has the characteristic of transmitting light while diffusing the light. As such a plastic material, for example, a light-transmitting plastic material, such as PMMA or PC, mixed with a white coloring agent, such as titanium oxide, calcium carbonate, or antimony oxide can be used. The lens 18 can be manufactured by injection-molding such a cloudy plastic material having a translucent milky white color or the like. The lens 18 includes a front plate 18a, and a rear plate 18c that is disposed facing the back side of the front plate 18a with a cavity 19 interposed therebetween. The front plate 18a has a predetermined plate thickness and is formed in a substantially vertically-elongated rectangular shape as a whole. To be easily distinguished from a lens for a left-side mirror (not shown), one of left and right corners of an upper part of the vertically-elongated rectangle of the front plate 18a is obliquely cut to form a cut portion 18h (FIGS. 3C, 3D). The rear plate 18c has substantially the same plate thickness as the front plate 18a and is formed in a substantially vertically-elongated rectangular shape smaller than the front plate 18a as a whole. Since the cavity 19 is positioned between the front plate 18a and the rear plate 18c, each of the front plate 18a and the rear plate 18c can be formed with a thin plate thickness. Thus, compared to a case in which the lens is formed of a solid thick plate lens having a combined size of the front plate 18a, the cavity 19, and the rear plate 18c, it is possible to reduce sink marks during molding and reduce unevenness in light emission of the icon. As shown in FIG. 3D, the rear plate 18c has a smaller area than the front plate 18a and is disposed within the surface of the front plate 18a. The rear plate 18c is disposed inclined obliquely upward relative to the front plate 18a. This forms the cavity 19 into a wedge shape that narrows downward and expands upward. The left, right, and lower sides of the cavity 19 are closed by a coupling portion 18d that integrally couples the front plate 18a and the rear plate 18c. An opening 18e that allows the cavity 19 to communicate with an external space of the cavity 19 is formed on the upper side of the cavity 19. Accordingly, the entire periphery of the cavity 19 except the upper opening 18e is closed by the coupling portion 18d, and the cavity 19 is formed in a bag shape. The size of an area of the cavity 19 is set in such a manner that, when viewed from the front of the front plate 18a, the entire icon is displayed at a position that falls within the area of the cavity 19 (the area surrounded by the coupling portion 18d and the opening 18e). A long dashed double-short dashed line 30 in FIG. 4 indicates a position on the front face 18a1 of the front plate 18a (the light emitting surface 12a), the position facing the light transmissive portion 24 of the mirror plate 10, that is, an icon display position. Note that the shape of the icon is formed of the light transmissive portion 24 (FIGS. 1, 2) of the mirror plate 10 disposed on the front side of the front plate 18a. The entire front face 18a1 itself of the front plate 18a emits light. Both the front face 18a1 and a back face 18a2 of the front plate 18a are formed as smooth surfaces without large irregularities so as to prevent unevenness in light emission of the icon at least at the entire positions (parts) where the icon is placed. Two ribs 18f that support the lower face of the PCB 16 are formed in a protruding manner on an upper part (at a position that does not overlap the icon when viewed from the front) of the back face 18a2 of the front plate 18a. Two protrusions 18g are formed in a protruding manner on the left and right sides of a lower part of the back face 18a2 of the front plate 18a. These protrusions 18g are inserted into positioning holes 14d (FIG. 2) of the housing 14 to position the lens 18 in the housing 14. Lugs 18i are formed on left and right side parts of a center part, in the up-down direction, of the back face 18a2 of the front plate 18a. These lugs 18i are fitted into lug receiving portions 14f (FIG. 2) formed at corresponding positions on the front opening 14a of the housing 14 to cause the lens 18 to be fitted and attached into the front opening 14a. FIG. 5 shows a state in which the lens 18 is fitted into the front opening 14a and mounted on the housing 14. An area 18c′ (FIG. 3B and others) on one of the left and right sides of the rear plate 18c is formed as an inclined surface obliquely connected to the coupling portion 18d. The inclined surface is formed as a result of increasing the thickness of a mold (male mold) for forming the cavity 19 by overlay welding to enhance the strength of a tip of the mold. Thus, the fact that the area 18c′ of the rear plate 18c is formed as the inclined surface is not particularly important as the function of the rear plate 18c, and the inclined surface may be eliminated (e.g., the entire rear plate 18c may be formed as a continuous surface such as a flat surface).

FIG. 1 shows a state in which the BSM light emitting unit 12 of FIG. 2 is stuck and mounted onto the back face of the mirror plate 10 with the double-sided adhesive tape 28 and a state in which the LED 20 is turned on to cause the icon to emit light (light emitted from the LED 20 is indicated by arrow 34). The PCB 16 is disposed in a position at a substantially right angle to the surface of the mirror plate 10. An optical axis 20a of the LED 20 is disposed substantially parallel to the surface of the mirror plate 10. The LED 20 is disposed facing downward at a position facing the cavity 19. A part of the reflective film 26 (in FIG. 1, the film thickness of the reflective film is exaggerated) on the back face of the mirror plate 10 at the place where the icon is to be displayed is removed in the icon shape (a triangular shape in front view) to form the light transmissive portion 24. The window 28a is formed in the double-sided adhesive tape 28 so as not to block the light transmissive portion 24. The LED 20 is disposed at a position that is not visible through the light transmissive portion 24 when the light emitting surface 12a is viewed from the front (the position where the LED 20 is hidden by a non-transmissive portion around the light transmissive portion 24).

The behavior of the light 34 emitted from the LED 20 will be described. The light 34 emitted from the LED 20 is introduced into the cavity 19 through the opening 18e. A part of the light 34 introduced into the cavity 19 is applied to the rear plate 18c. A part of the light applied to the rear plate 18c is reflected by a front face 18c1 of the rear plate 18c and applied to the front plate 18a. Another part of the light applied to the rear plate 18c enters the interior of the rear plate 18c from the front face 18c1 of the rear plate 18c, is reflected by a coloring agent in the interior, and is emitted from the front face 18c1 of the rear plate 18c and applied to the back face 18a2 of the front plate 18a. A part of the light 34 that has entered the interior of the rear plate 18c is transmitted through the rear plate 18c and exits from the back face 18c2 of the rear plate 18c. However, this exiting light is blocked by the housing 14 and thus does not leak to the outside of the BSM light emitting unit 12. In addition, another part of the light 34 introduced into the cavity 19 is directly applied to the back face 18a2 of the front plate 18a. The light 34 applied to the back face 18a2 of the front plate 18a (the light reflected by the rear plate 18c, the light coming directly from the LED 20, etc.) is transmitted through the front plate 18a while diffusing. The transmitted light is shaped into the icon shape at the light transmissive portion 24, is transmitted through the mirror plate 10, and is radiated to the outside. As a result, a light emitting display of the icon is visually recognized from an eye point 36 of a driver. In this case, since the front plate 18a and the rear plate 18c can be formed with a thin plate thickness, compared to a case in which the lens is formed of a thick plate having a combined size of the front plate 18a, the cavity 19, and the rear plate 18c, it is possible to reduce sink marks during molding and reduce unevenness in light emission of the icon. In particular, since the icon having a triangular shape has a large light emission area, unevenness in light emission is likely to be noticeable. Thus, the effect of reducing unevenness in light emission is large. In addition, since the cavity 19 is formed in a bag shape with the left, right, and lower sides closed, it is possible to reduce the amount of light leaking from the cavity 19 and efficiently use light for light emission of the icon.

Although, in the lens of the embodiment, the cavity is formed in a bag shape by continuously surrounding the entire periphery of the cavity by the coupling portion except the position of the opening through which light from the light source is introduced, this is not a limitation. That is, the cavity may be formed in a bag shape by surrounding a part of the entire periphery of the cavity by the coupling portion (e.g., by discontinuously providing the coupling portion along the circumferential direction of the cavity, that is, dividing the coupling portion and providing the divided coupling portions at a plurality of places) except the position of the opening through which light from the light source is introduced. In addition, the cavity does not necessarily need to be formed in a bag shape. In addition, the place where the opening is formed is not limited to an upper part around the cavity. That is, the opening may be formed on a side part, a lower part, or the like around the cavity. In addition, a lens cut may be applied to the lens, or a reflective film or a coating film may be formed on the lens. In addition, the color of the lens does not necessarily need to be white, and the lens may be colored yellow or the like.

Although, in the lens of the embodiment, the front plate and the rear plate are integrally coupled by the coupling portion, this is not a limitation. That is, the front plate and the rear plate may be formed of separate components and incorporated into the BSM light emitting unit.

Although, in the lens of the embodiment, an additional light transmissive member is not disposed between the front face of the front plate and the light transmissive portion that shapes light into the icon shape, an additional light transmissive member (e.g., an additional light diffusing plate) may be interposed therebetween. In addition, the icon shape is not limited to a triangular shape. In addition, the icon is not limited to being displayed on the mirror surface.

1. A lens for a blind spot monitor comprising:
a front plate;
a rear plate disposed facing a back side of the front plate with a cavity interposed therebetween;
a coupling portion that integrally couples the front plate and the rear plate around the cavity; and
an opening that allows the cavity to communicate with an external space of the cavity, wherein
the front plate is configured to have a characteristic of transmitting light while diffusing the light,
the rear plate is configured in such a manner that a front side of the rear plate facing the front plate has a characteristic of reflecting light while diffusing the light,
the opening is configured to enable light from a predetermined light source to be introduced into the cavity through the opening, and
the lens is configured to enable light from the light source that is transmitted through the front plate from the back side of the front plate to a front side of the front plate to be used for light emission of an icon.

2. The lens for a blind spot monitor according to claim 1, wherein the coupling portion is configured to couple the front plate and the rear plate along a circumferential direction of the cavity, and the cavity is surrounded by the coupling portion and formed in a bag shape.

3. The lens for a blind spot monitor according to claim 1, wherein the opening is formed between the front plate and the rear plate.

4. The lens for a blind spot monitor according to claim 1, wherein the rear plate is disposed inclined relative to the front plate toward the opening.

5. The lens for a blind spot monitor according to claim 1, wherein the lens is made of an integrally-molded article of a cloudy plastic material having a characteristic of transmitting light while diffusing the light.

6. A blind spot monitor light emitting unit comprising:
a light source; and
a lens that receives light from the light source, transmits the light, and emits the light from a predetermined light emitting surface, wherein
the lens includes
a front plate that has the light emitting surface,
a rear plate disposed facing a back side of the front plate with a cavity interposed therebetween, and
an opening that allows the cavity to communicate with an external space of the cavity,
the front plate is configured to have a characteristic of transmitting light while diffusing the light,
the rear plate is configured in such a manner that a front side of the rear plate facing the front plate has a characteristic of reflecting light while diffusing the light, and
light from the light source is disposed in such a manner that the light is introduced into the cavity through the opening.

7. A blind spot monitor light emitter comprising:
a light source;
a lens that receives light from the light source, transmits the light, and emits the light from a predetermined light emitting surface; and
a light transmissive portion that is disposed in front of the light emitting surface and shapes a cross-sectional shape of light emitted from the light emitting surface in a direction perpendicular to an optical axis into a predetermined icon shape, wherein
the lens includes
a front plate that has the light emitting surface,
a rear plate disposed facing a back side of the front plate with a cavity interposed therebetween, and
an opening that allows the cavity to communicate with an external space of the cavity,
the front plate is configured to have a characteristic of transmitting light while diffusing the light,
the rear plate is configured in such a manner that a front side of the rear plate facing the front plate has a characteristic of reflecting light while diffusing the light,
light from the light source is disposed in such a manner that the light is introduced into the cavity through the opening, and
the light source is disposed at a position that is not visible through the light transmissive portion when the light emitting surface is viewed from a front.
